(19) United States
(12) Patent Application Publication
(10) Pub. No.: US 2002/0168186 A1
(43) Pub. Date: Nov. 14, 2002

(54) Photographic flash apparatus

(76) Inventor: Jacques Jeudi, Asbury Park, NJ (US)

Correspondence Address: CLIFFORD G. FRAYNE, Suite 7A, 136 Drum Point Road, Brick, NJ, 08723, US

(21) Appl. No.: 09/853,181

(22) Filed: May 11, 2001

(51) Int. Cl. G03B 15/03

(52) U.S. Cl. 396/182

(57) ABSTRACT

A photographic flash unit comprising a housing containing the electronic circuitry for the flash unit, the housing having a slave member for attachment to a photographic camera, a power source adaptor and control means, the photographic flash unit having mounted thereon two independent flash units in side by side relationship, each flash unit independently rotatable about its vertical axis to allow indirect lighting of the subject matter of the flash, each of said flash members being pivotal on their vertical axis from the front of the housing to the rear of the housing in order to permit indirect, bounce lighting of the subject matter. The independent flash units may also be mounted on foldable, extensible arms so that they can be positioned to the lateral side of the housing.

### BACKGROUND OF THE INVENTION

1. Field of the Invention

The present invention relates to a photographic flash apparatus for cooperation with a camera for taking photographs, and in particular, to a flash apparatus having a pair of light emitting members which are independently rotatable on their axes and also in pivotal relationship with each other and a camera to permit greater latitude by the photographer with respect to the illumination of the subject.

2. Description of the Prior Art

Photographers use artificial lighting means in order to achieve the aesthetic appearance on film that they desire. Professional photographers working in a studio have the ability to position lights and screens in order to sufficiently illuminate the subject such that photographs can be taken without a flash unit associated with the camera.

Outside the studio a professional photograph must sometime resort to an artificial lighting means which consists of a flash unit associated with the camera. It is this type of flash unit that most amateurs are familiar with and utilize. In many instances, a flash unit is built into the camera, and in many other instances, such as with a full body 35 mm camera, the flash unit is separate and seats on the camera and is energized by the depression of the shutter on the camera. When taking photographic exposures, particularly indoors, the flash unit is required and it is known that in order to obtain an agreeably diffused result, the flash unit should be aimed away from the subject to be photographed and that the walls and/or the ceiling could thereby cause the light to bounce toward the subject, hence the term bounce flash applies to this technique.

The opposite of indirect flash, or bounce flash, is that of direct flash, in which the flash unit is directed at the subject. Direct flash can produce a photograph which has an unnatural appearance and the bounce flash can produce a photograph with undesirable shadows. It is therefore desirable to have a flash unit in which the photographer can adjust the direction of one flash unit to achieve indirect lighting and another flash unit to achieve direct lighting, thus harmonizing the lighting for the photographic exposure. Attempts have been made to provide a mount for a camera which mount can support multiple illumination sources, but to the best of Applicant's knowledge, these apparatus have been bulky and cumbersome. U.S. Pat. No. 3,550,519 to Lewis; U.S. Pat. No. 3,374,342 to Hutchins; U.S. Pat. No. 2,682,816 to Walden. Applicant's compact flash apparatus overcomes the shortcomings of the prior art.

### OBJECTS OF THE INVENTION

An object of the present invention is to provide for a flash unit for a camera which permits the photographer to illuminate the subject with both direct light and indirect light simultaneously.

Another object of the present invention is to provide for a novel flash assembly comprising two flash units which are rotatable about their axes and simultaneously pivotally rotatable with respect to each other.

A further object of the present invention is to provide for a flash apparatus in which the photograph can control the timing of the flash of either flash unit independently.

A still further object of the present invention is a novel flash apparatus which is adaptable to standard camera flash seats.

### SUMMARY OF THE INVENTION

A photographic flash apparatus removably securable to a camera and having two independent light emitting flash members moveably mounted thereon whereby said independent light emitting flash members can be rotated independently about their vertical axis; tilted rearwardly, independently on their vertical axis; and independently extensible on a selected plane between the horizontal and vertical axis of the light emitting flash members.

### BRIEF DESCRIPTION OF THE DRAWINGS

These and other objects of the present invention will become apparent, particularly when taken in light of the following illustrations wherein:

FIG. 1 is a front view of the photographic flash apparatus;

FIG. 2 is a side view of the photographic flash apparatus;

FIG. 3 is a rear view of the photographic flash apparatus;

FIG. 4 is a schematic of the extension arms of the flash unit.

### DETAILED DESCRIPTION OF THE DRAWINGS

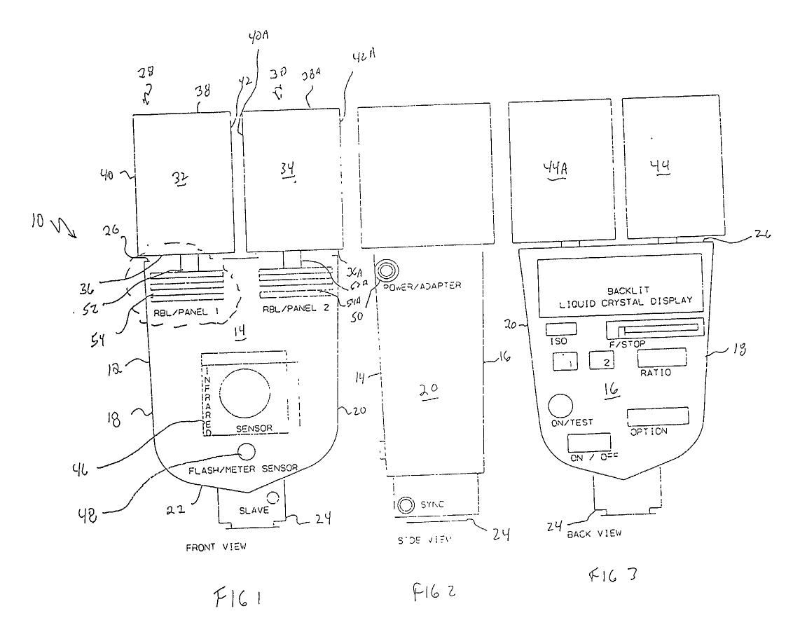

FIG. 1 is a front view of the photographic flash apparatus indicated generally as 10 of the present invention. The photographic flash apparatus 10 comprises a body member 12 having a front face 14, a rear face 16, and side faces 18 and 20. Incorporated in body member 12 and extending from the lower surface 22, is a slave connector 24 designed to be slidably received into a complimentary connector mounted on a standard 35 mm camera or the like. Top surface 26 of housing 12 provides for the positioning of two independent light emitting flash units 28 and 30. The light emitting flash units 28 and 30 illustrated in FIGS. 1, 2, and 3 for purposes of this application are shown to be generally rectangular in cross-sectional area having a transparent or translucent front face 32 and 34 to permit the passage of light therethrough from the light generating source (not shown) within the light emitting flash members. With respect to light emitting flash member 28, the bottom and top walls 36 and 38, the side walls 40 and 42, and the rear wall 44 are opaque. Light emitting flash member 30 is identical to light emitting flash member 28 with respect to side walls 40A and 42A, top and bottom walls 36A and 38A, and rear wall 44A.

As illustrated in FIG. 1, the housing member 12 of photographic flash apparatus 10 contains certain infrared and flash meter sensors 46 and 48 on the front surface which are in electronic communication with the electronics of the flash unit positioned within housing 12.

Considering FIG. 2, a side view of the photographic flash apparatus, there is illustrated a power/adaptor 50. The photographic flash apparatus of the present invention does not have its own inboard power source and therefore is in communication with an external power source (now shown) in order to power up the light generating sources.

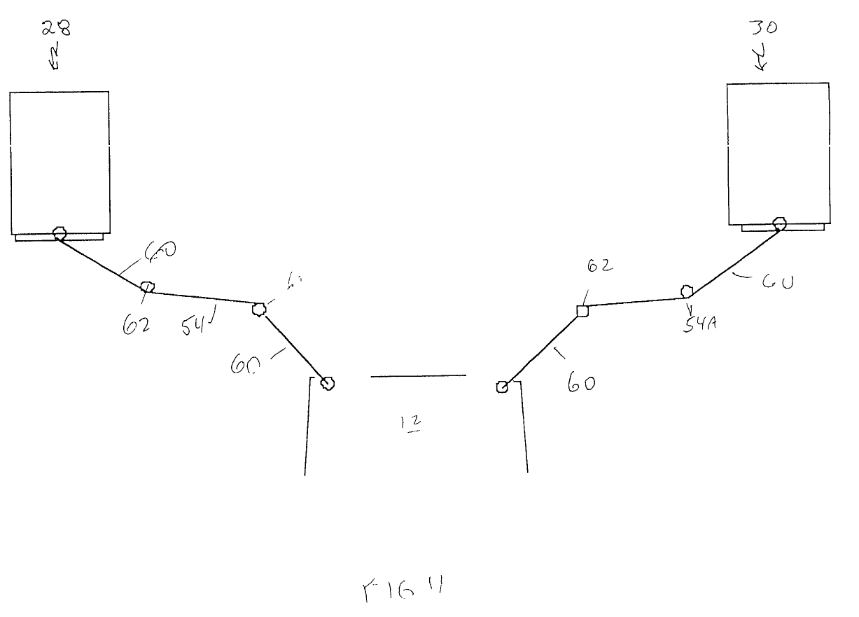

The rear face 16 of the housing 12 is illustrated in FIG. 3 and provides for a liquid crystal display screen to provide various data and information to the photographer regarding the readiness of the flash and the requirements of the photograph which he is about to take.

Referring back to FIG. 1, it can be seen that the light emitting flash members 28 and 30 are mounted by means of a ball joint assembly 52 and 52A to two independent extensible arms 54 and 54A. In this configuration, the light emitting flash members 28 and 30 can be rotated about their vertical axis with respect to each other. As an example, light emitting flash member 28 may be left in a direct frontal position pointing directly ahead whereas the light emitting flash member 30 may be rotated about its vertical axis such that its flash will bounce out to the side of the subject matter of the photograph.

Additionally, the photographer has the option of activating both light emitting flash members simultaneously, under delay, and to activate selectively only one of the light emitting flash members. The user also has off camera flash synchronization capability via synchronous contact 19.

In addition to rotating about the vertical axis, the light emitting flash members 28 and 30 can tilt on their vertical axis rearwardly independently of each other. This permits the photograph to utilize one or both of the light emitting flash members to achieve the bounce light effect on the subject matter of the photograph. Both light emitting flash units 28 and 30 could be tilted, or only one could be so tilted and the other remain in a direct line of sight in order to harmonize the lighting for the photographic exposure by providing for direct and bounce lighting. In this arrangement, the photographer has the same options as when the light emitting flash units 28 and 30 are rotated about their vertical axis. They may fire simultaneously or with delay.

Finally, light emitting flash members 28 and 30 can be extended away from housing member 12 by means of extensible arms 54 and 54A which permit the light emitting flash members 28 and 30 to be independently positioned in a horizontal axis, a distance of approximately 3¾ inches from the center line of the housing member 12. Extensible arms 54 and 54A are comprised of a plurality of arm segments 60 which are linked by a plurality of hinges 62. Hinge members 62 are lockable such that the user can fix the angular relationship between adjacent arm segments 60. The arm segments 60 and the hinge members 62 are foldable upon themselves such that extensible arms 54 and 54A are stored in a recess of the top surface of housing 12 and when so positioned, position flash units 28 and 30 in their normal position on the top surface of housing 12. This again allows the photographer to achieve desirable lighting effects on the subject matter of the photograph. A greater angle can be achieved for direct light or bounce light.

Extensible arms 54 and 54A also allow the light emitting flash members to be extended vertically from the body 12 and to be positioned in a selected angular plane between the vertical axis of the body member 12 and the horizontal plane of the top wall 26 of the body member 12.

The invention has been described with respect to the exemplary embodiment thereof and it will be recognized by those of ordinary skill in the art that many changes and modifications can be made without departing from the spirit and scope of the invention. Therefore it is manifestly intended that the invention be limited only by the claims and the equivalents thereof.

I claim:

1. A photographic flash apparatus comprising:
a housing for the electronic circuitry of a photographic flash apparatus, said housing comprising a casing having a front face, a rear face, opposing side faces, and a bottom face having a slave member depending therefrom for attachment to a photographic camera, said front face of said casing having formed therein, an infrared sensor and a flash meter sensor, said rear face of said casing having a plurality of liquid crystal displays and the informational windows providing data regarding the lighting of the subject matter, there also being positioned on the casing, an adaptor for connection to a power source and a synchronous connection for communication with said photographic camera;
two independent flash units in side by side relationship, positioned on the upper surface of said casing, said flash units independently rotatable about their vertical axis so as to allow light from said independent flash units to be directed indirectly at said subject of said flash, said flash members being pivotal on their vertical axis and orientation from front face to rear face in order to permit the indirect lighting of the subject matter of the photograph.

2. The photographic flash apparatus in accordance with claim 1 wherein independent flash units are mounted to said top surface of said housing by means of two independent spherical connectors, each of said independent flash units secured to a separate independent spherical connector, said spherical connectors being rotatably secured in the upper surface of said casing permitting the independent rotation and pivoting of said flash units.

3. The photographic flash apparatus in accordance with claim 2 wherein each of said two independent spherical connectors are rotatably secured to an arm member of a foldable extension member positioned on said top surface of said housing, said extension member having a plurality of lockable, hinged arms permitting the independent extension of said flash units to lateral position from said housing.

4. The photographic flash apparatus in accordance with claim 3 which said lateral position is 3¾ inches from said housing.
